(19) United States
(12) Patent Application Publication
(10) Pub. No.: US 2005/0216464 A1
(43) Pub. Date: Sep. 29, 2005

(54) Automated authoring tool and method to facilitate inclusion of maps and other geographical data into travelogues

(75) Inventors: Kentaro Toyama, Redmond, WA (US); Ronald Keith Logan, Everett, WA (US); Asta Roseway, Redmond, WA (US)

Correspondence Address: LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 10/810,376

(22) Filed: Mar. 27, 2004

(51) Int. Cl. G06F 7/00

(52) U.S. Cl. 707/9; 707/10

(57) ABSTRACT

An automated or semi-automated authoring tool and method for incorporating maps and other geographical data in combination with text, photographs, and other multimedia data associated with a trip to produce a travelogue of the trip. The geographical travelogue authoring tool and method includes a number of geographically-oriented features that provide automation and are useful when blending the geographical data into the geographic travelogue. The geographic travelogue authoring method includes obtaining content items that are associated with a trip and geographically coding these content items. This serves to associate a geographic location from the trip with the content item. A map then is selected based on the trip, and the map and the geo-coded content items are automatically integrated with other multimedia data to generate the geographic travelogue.

### TECHNICAL FIELD

The present invention relates in general to the processing of multimedia data using a computing device and more particularly to a system and method for automating the process of authoring a geographic travelogue of a trip including automatic integration, association, combination and creation of maps and other geographic data.

### BACKGROUND OF THE INVENTION

Throughout history people have shared with others accounts of their travels and adventures. These accounts, which typically are accompanied by an audio and visual presentation, are commonly referred to as “travelogues”. Before the invention of the photograph, early travelogues consisted primarily of the spoken word, along with artifacts or souvenirs collected during the travels. Later, travelogues included the lecture and souvenirs accompanied by a film, a video, slides and/or photographs of the trip.

Currently, the explosive growth of the Internet has provided a large forum for people to share their travelogues. A casual search of the Internet yields over half a million web sites pertaining to people displaying their travelogues. These travelogues typically are multimedia presentations of varying degree, which may contain some or all of the following: photographs, text, audio, maps and other types of multimedia data.

One problem, however, is that the production of these travelogues generally requires vast amounts of time. The travelogue must be tediously handcrafted such that each piece of multimedia data is positioned and incorporated manually. Depending on their complexity, the production of a single travelogue can take from hours to days. Even though these travelogues typically are labors of love for those wishing to share their travels, it is desirable to automate, assist, and otherwise simplify the travelogue authoring process.

The inclusion of maps and other geographical data adds significant interest and value to a travelogue. Maps and other geographical data greatly enhance a viewer's travelogue experience. A variety of maps may be used depending on the need, such as a city street map or a topographical map. Geographical data may be expressed in a variety of different reference systems, such as, for example, place names (e.g. Seattle, Wash.), longitude/latitude, and personal (e.g., “Grandma's house”).

One problem, however, with adding maps and other geographical data is that this increases the complexity of both the authoring and viewing processes. In particular, this requires a travelogue author to perform many tedious and time-consuming tasks. These tasks include, for example, selecting the type of maps to use, and correlating the multimedia data to the maps and other geographical data. It is desirable to automate and simply the inclusion of maps and other geographical data into travelogues.

Accordingly, there exists a need for a travelogue authoring system that automates and simplifies the authoring of travelogues produced on a computing device. In addition, there is a need for a travelogue authoring system and method that facilitates and automates the inclusion of maps and other geographical data along with other types of multimedia data into travelogues.

### SUMMARY OF THE INVENTION

The invention disclosed herein includes a geographic travelogue authoring tool and method that automates the authoring of travelogue and allows the inclusion of a rich use of maps and other geographic data in combination with other multimedia data, such as text and images. The addition of maps in the travelogue greatly enhances the travelogue viewing experience. In addition, the automation of the authoring of these geographic travelogues greatly reduces the tedious nature of the task and decreases the amount of time a user spends authoring.

The geographic travelogue authoring tool obtains trip information about a trip, processes this trip information, and outputs a geographic travelogue that includes maps. The trip information includes subjects, content items, and tracks. A subject includes a person, an object, or sets thereof, which traveled together on a trip (or trips) over some interval of time. A content item includes any piece of displayable information (such as a block of text, an image, a video, or a link to a web page). Tracks include a record of where a subject traveled during the trip over some span of time. The authoring tool uses a geographic coder to mark (or tag) the content items with their associated geographic location from the trip to produce a geo-coded content item. A map selection module selects a map that corresponds to the geographic location of the geo-coded content item, and a content item and map layout module automatically incorporates the geo-coded content items, maps, and other multimedia data associated with the trip to produce the geographic travelogue.

The geographic travelogue authoring tool operates using the geographic travelogue authoring method. The geographic travelogue authoring method begins by obtaining content items that are associated with a trip and geographically codes these content items. This serves to associate a geographic location from the trip with the content item. A map then is selected based on the trip, and the map and the geo-coded content items are automatically integrated with other multimedia data (such as text, video, and photographs) to generate the geographic travelogue.

The geographic travelogue authoring tool and method include a number of geographically-oriented features that are beneficial when incorporating geographical data into a travelogue. These features include a location resolver that converts between various location reference systems. For example, if a map expresses location in a map location reference system and a geo-coded content item is expresses location in a content item location reference system, the location resolver converts the geo-coded content item to the map location reference system and vice versa.

The geographic travelogue authoring tool and method also include a clustering module that provides automatic clustering of content items by location. Based on the geo-coding, one or more clustering techniques are used to cluster the geo-coded content items. These clusters are sets of geo-coded content items that are identified as belonging to distinct clusters. The geographic travelogue authoring tool and method also include a cluster-integration module that can perform a number of operations on the clustered content items. For example, the appearance of content items on a map may be simplified by reducing the number of visual elements representing the content items. The cluster-integration module also may create a hierarchical organization of travelogue pages. The travelogue may also be split into multiple travelogues such that a “flat” set of travelogues is created for each of the clusters. Moreover, certain content items may also be excluded from a cluster. The cluster-integration module also includes the feature of automatically titling each cluster.

Another feature included in the geographic travelogue authoring tool and method is the map-selection module. The map-selection module automatically selects maps used in the geographic travelogue, including map type, size and shape. The map's dimensions and shape are appropriately selected based on the geo-coded content items. The map type is automatically selected based on the geo-coded content items. A content item and map-layout module provides an automated layout of content items and selected maps within the travelogue. Geo-coded content items are automatically arranged on an appropriate map such that each content item is on or near its associated geographic location. Visual cues, which show a relationship between a content item and its associated location, can also be included. These visual cues can be active visual cues, passive visual cues, or both. Active cues dynamically change based on interaction from a user, while passive visual cues are statically viewable.

The geographic travelogue authoring tool and method also include multiple subject-integration modules that uses the subjects, content items, and tracks to perform a variety of operations. One such operation is the automatic identification of geographic intersection between multiple subjects. Another operation is the automatic identification of geographic and temporal intersections, whereby multiple subjects converged to the same location at overlapping times. The module also features the automatic selection of a special set of content items based on geographic clustering and subject. Another feature is multi-faceted hierarchical organization of travelogue pages.

Other features included in the geographic travelogue authoring tool and method are a track incorporation module that performs the automatic incorporation of tracks into the travelogue. This allows a viewer to experience the tracks in a number of different ways. The module can align and overlay the tracks onto a selected map, and can “snap” the tracks on known landmarks on the map. Visual cues can also be used to correlate the tracks with content item, and can be active, passive, or both. The tracks may also be dynamically displayed such that they are animated to show a path taken by the subjects. Additional content items may be added using an additional content-item generator. The generator automatically creates additional content items relevant to an existing content item or cluster's location. Based on the analysis of the location, additional content items may be added (such as a hypertext link that links to a web page).

### BRIEF DESCRIPTION OF THE DRAWINGS

The present invention can be further understood by reference to the following description and attached drawings that illustrate aspects of the invention. Other features and advantages will be apparent from the following detailed description of the invention, taken in conjunction with the accompanying drawings, which illustrate, by way of example, the principles of the present invention.

Referring now to the drawings in which like reference numbers represent corresponding parts throughout:

FIG. 1 is a block diagram illustrating an overview of the geographic travelogue authoring system.

FIG. 2 illustrates an example of a suitable computing system environment in which the geographic travelogue authoring system shown in FIG. 1 may be implemented.

FIG. 3 is a block/flow diagram illustrating the components of the geographic travelogue authoring system.

FIG. 4 is a general flow diagram illustrating the general operation of the geographic travelogue authoring system shown in FIGS. 1 and 3

FIG. 5 is a flow diagram illustrating the detailed operation of the location resolver shown in FIG. 3.

FIG. 6 is a flow diagram illustrating the detailed operation of the clustering module shown in FIG. 3.

FIG. 7 is a flow diagram illustrating the detailed operation of the clusters integration module shown in FIG. 3.

FIG. 8 is a flow diagram illustrating the detailed operation of the map selection module shown in FIG. 3.

FIG. 9 is a flow diagram illustrating the detailed operation of the content item and map layout module shown in FIG. 3.

FIG. 10 is a flow diagram illustrating the detailed operation of the multiple subjects integration module shown in FIG. 3.

FIG. 11 is a flow diagram illustrating the detailed operation of the track incorporation module shown in FIG. 3.

FIG. 12 is a flow diagram illustrating the detailed operation of the additional content item generator shown in FIG. 3.

### DETAILED DESCRIPTION OF THE INVENTION

In the following description of the invention, reference is made to the accompanying drawings, which form a part thereof, and in which is shown by way of illustration a specific example whereby the invention may be practiced. It is to be understood that other embodiments may be utilized and structural changes may be made without departing from the scope of the present invention.

I. Introduction

Travelogues typically are in the form of web sites featuring photographs, text, maps, and other types of geographical data. These travelogues are tediously and laboriously handcrafted by persons wishing to share tales of their travels and trips. At present, there are tools that allow a user to author travelogues manually containing photographs and text. However, there is a lack of authoring tools available that automates the authoring of travelogues and facilitates the inclusion of maps and other geographical information into these travelogues.

The geographical travelogue authoring tool and method described herein allow the incorporation of maps and other geographical data with text, photographs, and other multimedia data. The authoring tool and method include a number of geographically-oriented features that provide automation and are useful when blending the geographical data into the geographic travelogue. By way of example, content items are tagged or marked with a corresponding geographic location (“geo-coding”). Geo-coding content items allows automated matching of the items to maps. Correspondence between a map and a geo-coded content item is established using a location resolver. This location resolver is used in situations where the item's geo-coding is incompatible with a map. Automated clustering of content items by location allows sets of content items to be identified as belonging to distinct clusters. Using its rich array of features and a variety of data associated with a trip, the geographical travelogue authoring tool automates, assists, and otherwise simplifies the authoring of travelogues generated on a computing device. The result is an aesthetically-pleasing and professional travelogue suitable for viewing over the Web.

II. General Overview

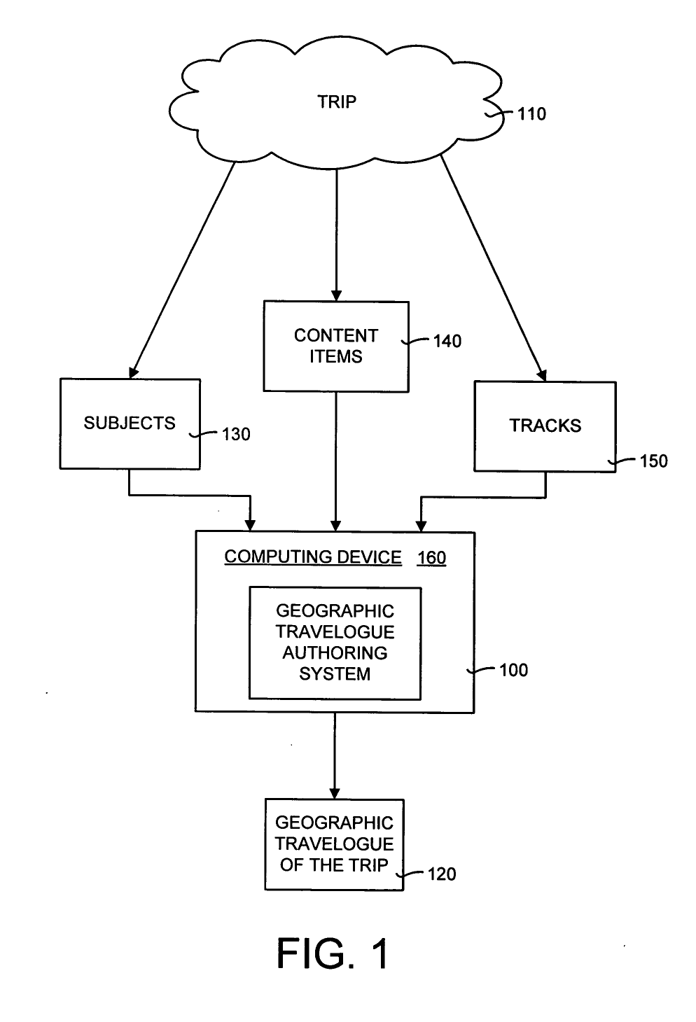

The geographic travelogue authoring system and method facilitates the authoring of travelogues that incorporate map and other geographical data with other types of multimedia data. FIG. 1 is a block diagram illustrating an overview of the geographic travelogue authoring system 100. In general, the system inputs information about a trip 110, processes the information, and outputs a geographic travelogue of the trip 120.

More specifically, the geographic travelogue authoring system 100 facilitates the authoring of a travelogue by a user about a trip 110. Typically, this is a trip 110 (or trips) that the user has taken. Trip information is collected for input to the system 100. This trip information includes subjects 130, content items 140, and tracks 150. Each of these pieces of trip information is discussed in detail below.

The geographic travelogue authoring system 100 resides on a computing device 160. The trip information is entered into the computing device 160 for processing by the system 100. As explained below, at least some of the trip information is geographically coded for use by the system 100. Geographic coding (or “geo-coding”) means that a piece of trip information (such as a photograph or block of text) is tagged with its geographic location. The geographic travelogue authoring system 100 uses this geo-coding to automatically authoring certain portions of the travelogue 120. The result is the geographic travelogue of the trip 120.

III. Exemplary Operating Environment

The geographic travelogue authoring system 100 and method are designed to operate in a computing environment and on a computing device, such as the computing device 160 shown in FIG. 1. The computing environment in which the geographic travelogue authoring system 100 and method operates will now be discussed. The following discussion is intended to provide a brief, general description of a suitable computing environment in which the geographic travelogue authoring system 100 and method may be implemented.

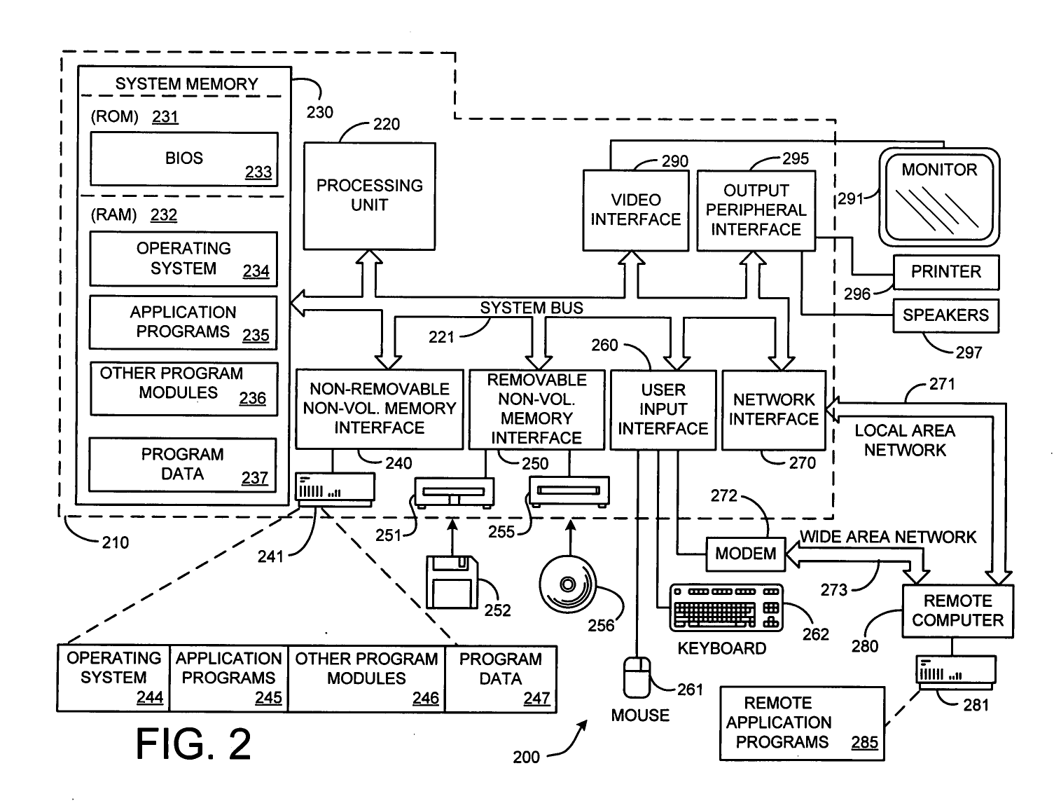

FIG. 2 illustrates an example of a suitable computing system environment in which the geographic travelogue authoring system and method shown in FIG. 1 may be implemented. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The geographic travelogue authoring system and method is operational with numerous other general purpose or special purpose computing system environments or configurations. Examples of well known computing systems, environments, and/or configurations that may be suitable for use with the geographic travelogue authoring system and method include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The geographic travelogue authoring system and method may be described in the general context of computer-executable instructions, such as program modules, being executed by a computer. Generally, program modules include routines, programs, objects, components, data structures, etc., that perform particular tasks or implement particular abstract data types. The geographic travelogue authoring system and method may also be practiced in distributed computing environments where tasks are performed by remote processing devices that are linked through a communications network. In a distributed computing environment, program modules may be located in both local and remote computer storage media including memory storage devices. With reference to FIG. 2, an exemplary system for implementing the geographic travelogue authoring system and method includes a general-purpose computing device in the form of a computer 210 (the computer 210 is one example of the computing device 160 shown in FIG. 1).

Components of the computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 210 typically includes a variety of computer readable media. Computer readable media can be any available media that can be accessed by the computer 210 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 210. Communication media typically embodies computer readable instructions, data structures, program modules or other data in a modulated data signal such as a carrier wave or other transport mechanism and includes any information delivery media.

Note that the term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within the computer 210, such as during start-up, is typically stored in ROM 231. RAM 232 typically contains data and/or program modules that are immediately accessible to and/or presently being operated on by processing unit 220. By way of example, and not limitation, FIG. 2 illustrates an operating system 234, application programs 235, other program modules 236, and program data 237.

The computer 210 may also include other removable/non-removable, volatile/nonvolatile computer storage media. By way of example only, FIG. 2 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, the hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a keyboard 262 and pointing device 261, commonly referred to as a mouse, trackball or touch pad.

Other input devices (not shown) may include a microphone, joystick, game pad, satellite dish, scanner, radio receiver, or a television or broadcast video receiver, or the like. These and other input devices are often connected to the processing unit 220 through a user input interface 260 that is coupled to the system bus 221, but may be connected by other interface and bus structures, such as, for example, a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

IV. System and Associated Components

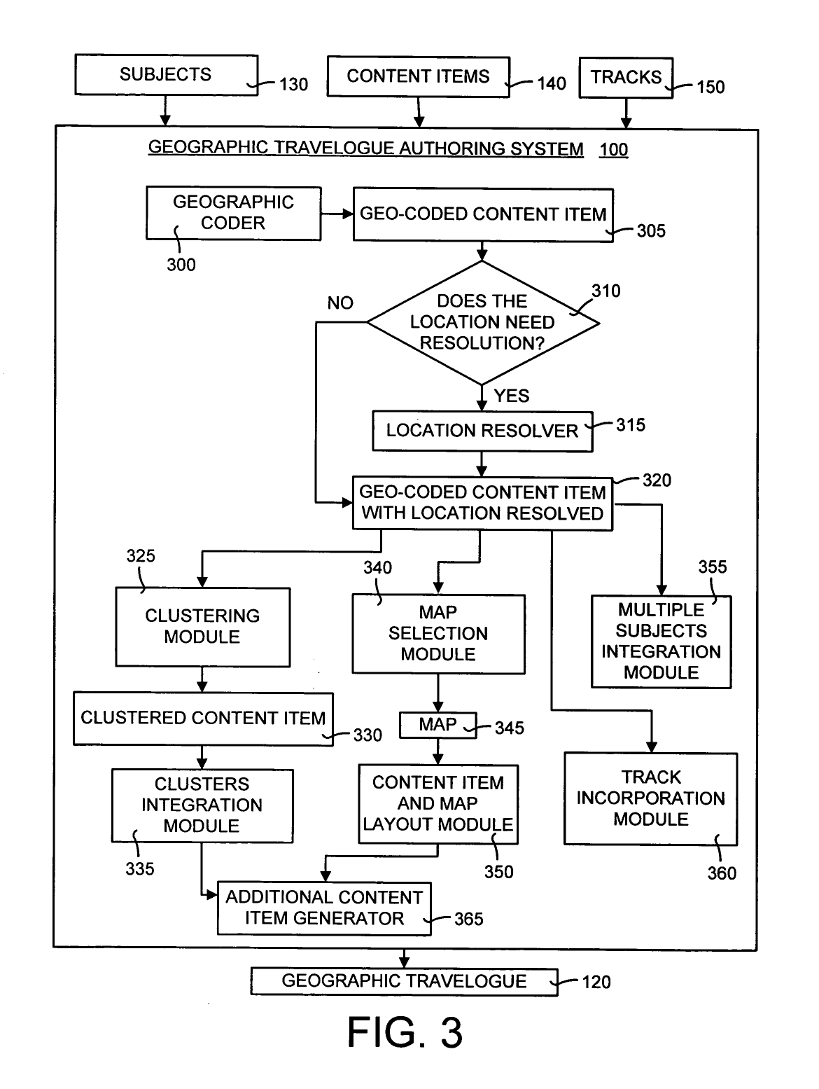

The geographic travelogue authoring system 100 shown in FIG. 1 includes a number of program modules that allow the system 100 to input trip information and automatically or semi-automatically produce a high-quality geographic travelogue of the trip. FIG. 3 is a block/flow diagram illustrating the components of the geographic travelogue authoring system 100. These program modules contained in the system 100 and their interaction now will be discussed.

Referring to FIG. 3, the input to the geographic travelogue authoring system 100 is information about a trip. This trip information includes subjects 130, content items 140, and tracks 150. For purposes of describing the program modules and their associated functions, a common vocabulary will first be established.

A subject includes a person, an object, or sets thereof, which traveled together on a trip (or trips) over some interval of time. A content item includes any piece of presentable information. For example, a content item could include a block of text, an image, a video, an audio clip, or a link to a web page. Tracks include a record of where a subject traveled during the trip over some span of time. Tracks may or may not be time stamped. Tracks are displayable on a map as the path that a subject traveled during the trip. Some or all of the subjects 130, content items 140, and tracks 150 are used by the geographic travelogue authoring system 100 in automatically or semi-automatically generating the geographic travelogue.

The geographic travelogue authoring system 100 includes a geographic coder 300 that geographically codes (“geo-coding”) the trip information, including the subjects 130, content items 140, and tracks 150. Typically, the content items 140 are the trip information that is most often geo-coded. A content item is said to be geo-coded if it is somehow associated with location metadata that indicates there is a relationship between the content item and a location. In other words, the content item is tagged (or marked) by its geographical location. For the purposes of this document, geo-coding includes an association between a content item and any type of geographic location data. This geographical location data is expressed in some type of location-reference system. This reference system may use various means to express location. For example, a location may be expressed using universally-established and understood means, such as longitude/latitude), a place name, a mail address, or using a personalized means, such as “Grandma's house”.

The output of the geographic coder 300 is a geo-coded content item 305. As stated above, the geo-coded content item 305 may have its location expressed in a number of different ways. A determination is made as to whether the geo-coded content item 305 needs its location resolved 310. If so, then a location resolver 315 is used to resolve the location. The location resolver 315 is any system that can convert between the various location reference systems (i.e., ways of indicating a location). For example, the location resolver 315 is capable of converting a content item that is a geo-coded by a mail address to a map that uses latitude/longitude. In this manner, the output of the location resolver 315 is a geo-coded content item with its location resolved 320. In addition, the location resolver can perform the reverse conversion, such as from latitude/longitude to the mail address. If the geo-coded content item 305 does not need its location resolved, the location resolver 315 is skipped.

The geo-coded content item with a resolved location 320 can be processed by any combination of the several modules contained in the geographic travelogue authoring system 100. In addition, these modules can also use the other types of trip information, such as the subjects 130 and the tracks 150. The following modules may use one or more of any combination of trip information as input to help in the generation of a geographic travelogue 120.

A clustering module 325 provides automatic clustering of geo-coded trip information based on geographic location. This groups each piece of trip information (such as a geo-coded content item with location resolved 320) into distinct clusters. Typically, a content item is processed by the clustering module 325 to produce a clustered content item 330. This clustered content item 330 is associated with a particular cluster usually containing other clustered content items. The geographic travelogue authoring system 100 also includes a clusters integration module 335. This integration module 335 automatically takes clusters found by the clustering module 325 and integrates each of the clusters into the geographic travelogue 120.

A map selection module 340 automatically selects and sizes a map based on the trip information. The output is a map 345 that becomes a part of the geographic travelogue 120. A content item and map layout module 350 provides automatic layout of the geo-coded content items 320 and the map 345.

A multiple-subject-integration module 355 integrates the trip information of several of the subjects 130 into the geographic travelogue 120. A tracks-incorporation module 360 automatically incorporates the tracks 150 such that the tracks are intelligently positioned within the geographic travelogue 120. Additional content-item generators 365 automatically create additional content items that are relevant to an existing location of a content item or a cluster. The result of processing the trip information by the above-mentioned modules of the geographic travelogue authoring system 100 is the geographic travelogue 120.

V. Operation

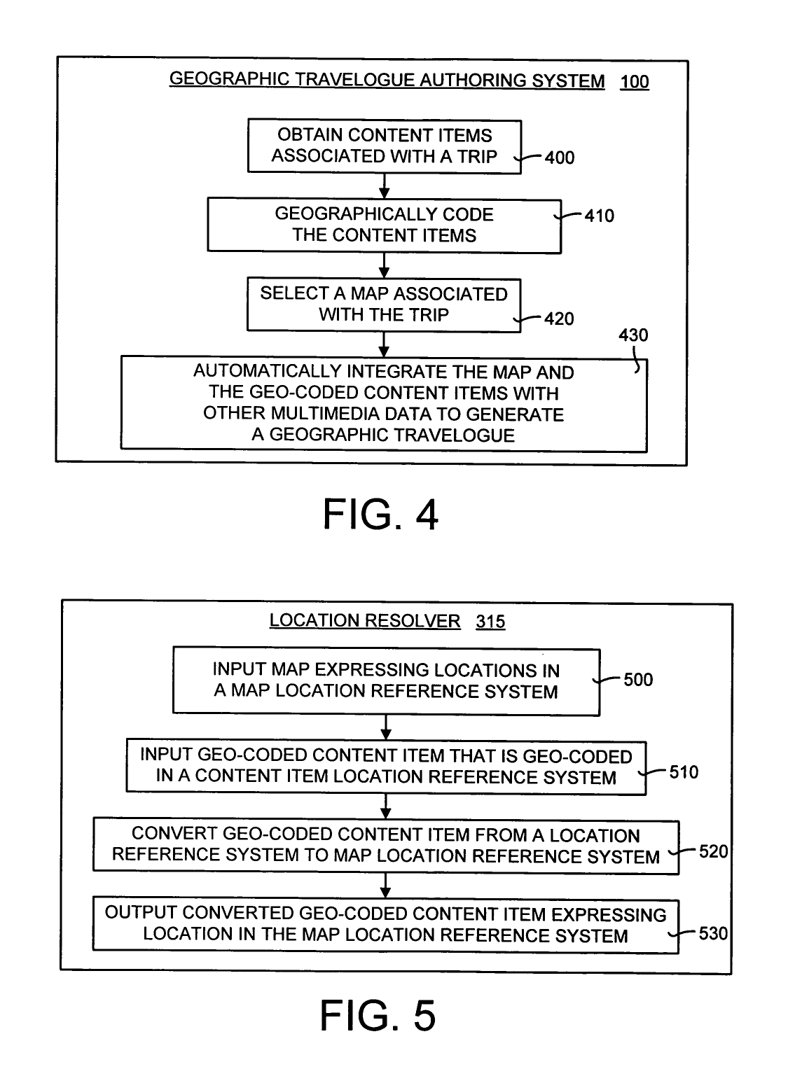

The geographic travelogue authoring system 100 discussed above operates using the geographic travelogue authoring method. The operation of the geographic travelogue authoring system 100 and method used therein shown in FIGS. 1 and 3 now will be discussed. FIG. 4 is a general flow diagram illustrating the general operation of the geographic travelogue authoring system 100 shown in FIGS. 1 and 3. The geographic travelogue authoring method begins by obtaining content items that are associated with a trip (box 400). As noted above, a content item is any piece of presentable information associated with the trip. Next, the content items are geographically-coded (box 410). This associates a location from the trip with the content item. A map then is selected based on the trip (box 420). For example, a map of a country may be selected to give an overview of a cross-country trip, while a city street map may be selected to describe the location of a famous address within the city. Finally, the map and the geo-coded content items are automatically integrated with other multimedia data (such as text, video, and photographs) to generate a geographic travelogue.

FIG. 5 is a flow diagram illustrating the detailed operation of the location resolver 315 shown in FIG. 3. In general, the location resolver converts between various location reference systems. In other words, the location resolver 315 automatically establishes correspondence between a map and a geo-coded content item in those situations when the content item's geo-coded location is incompatible with the map data. For example, if a set of content items are geo-coded only by their textual place names (such as “Boston” or “Seattle”), they cannot be immediately associated with a map for which only latitude/longitude coordinates are known. The location resolver 315 is used to convert the textual place names to latitude/longitude coordinates.

In particular, as shown in FIG. 5, a map is input that expresses location in a map location reference system (box 500). Further, a geo-coded content item is input, whereby the content item is geo-coded in a content item location reference system (box 510). Next, the geo-coded content item in a location reference system is converted to the map location reference system (box 520). The geo-coded content item expressed in the map location reference system then is output (box 530).

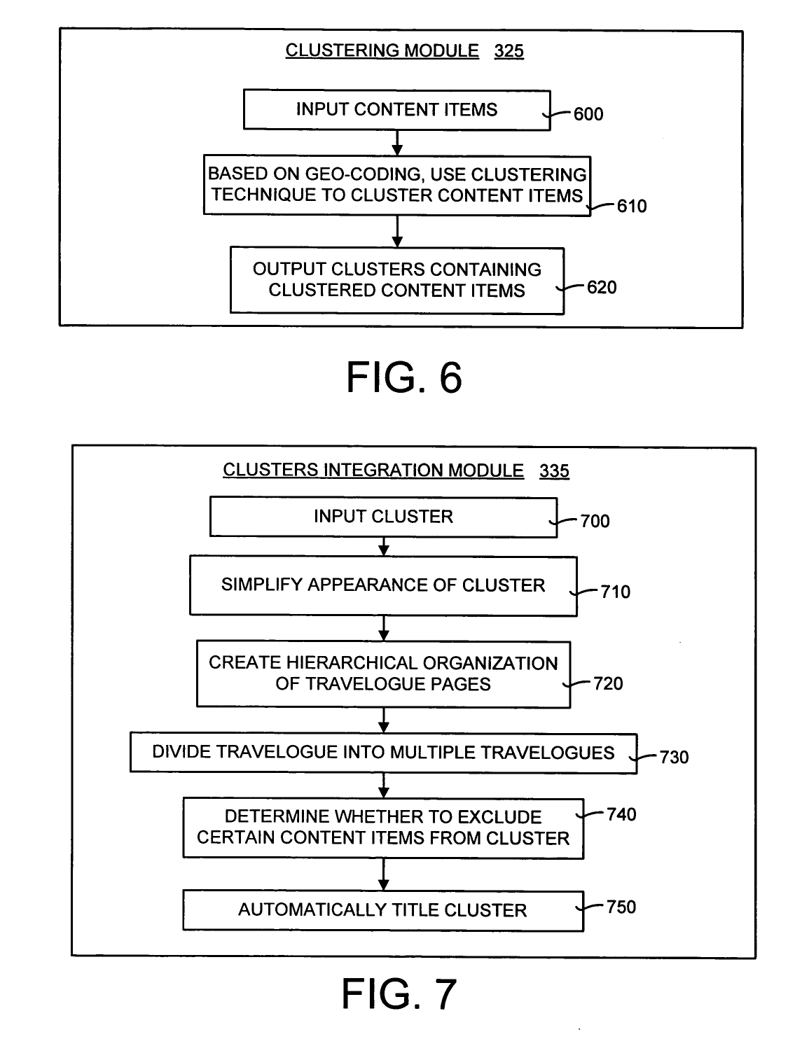

FIG. 6 is a flow diagram illustrating the detailed operation of the clustering module 325 shown in FIG. 3. The clustering module 325 provides automatic clustering of content items by location. As shown in FIG. 6, the clustering module inputs the geo-coded content items (box 600). Next, based on the geo-coding, one or more clustering techniques are used to cluster the geo-coded content items (box 610). The clustering techniques include, but are not restricted to, agglomerative clustering, k-means clustering, expectation-maximization clustering (to name a few) which may use a variety of distance functions and cluster representations. The foregoing clustering techniques are well known in the art and will not be discussed in detail. Finally, clusters are output that contain clusters of the geo-coded content items (box 620). The clusters are sets of geo-coded content items that are identified as belonging to distinct clusters.

FIG. 7 is a flow diagram illustrating the detailed operation of the clusters integration module 335 shown in FIG. 3. The clusters integration module 335 can be used to perform any of the following features on the clustered content items. The clusters integration module 335 first inputs a cluster containing the geo-coded content items belonging to that cluster (box 700). Next, the appearance of the cluster may be simplified (box 710). In particular, the appearance of content items on a map may be simplified by reducing the number of visual elements representing the content items. For example, if there are 100 content items in a cluster, and 50 of the content items are pertaining to New York City and 50 pertain to Seattle, a travelogue map of the United States might include only two visual elements. Namely, one visual element would be for New York City and the other visual element would be for Seattle, as opposed to 100 elements crowding out each other in the respective cities.

The clusters integration module 335 may also create a hierarchical organization of travelogue pages (box 720). By way of example, one page of the travelogue may include a map of Europe with clusters in London, Paris, and Berlin. Each of there clusters may lead to more focused pages. For instance, the London page may consist of clusters near Piccadilly Circus, Big Ben, and Buckingham Palace. In this example, the content items may also be hierarchically organized so that the majority of London images are only accessible from the London travelogue page. The travelogue may also be split into multiple travelogues (box 730). Thus, instead of a hierarchical organization, a “flat” set of travelogues can be created for each of the clusters.

Certain content items may also be excluded from a cluster (box 740). When one cluster contains a large amount of content items in relation to another cluster, this determination is made based upon at least two criteria. For example, if one cluster contains 99 content items and another contains only 1 content item, there are at least two options. One option is to eliminate some percentage of the 99 content items in the first cluster, because that cluster is over-represented. This process may be undertaken in a variety of ways, including, but not limited to a random selection process, or a representative-item selection process which creates sub-clusters of items based on some similarity metric and chooses a limited number from each cluster. A second option is to eliminate the single-item cluster altogether, as it is likely to be an outlier in the content-item data.

The clusters integration module 335 also includes the feature of automatically titling each cluster (box 750). This automatic titling is performed using appropriate place names. For example, if there is a cluster of 50 photographs in New York and 50 photographs in Washington, these two groups could be separated into two separate pages. Each of these two pages would be automatically labeled by place name. This may involve the use of the location resolver 315 to resolve location.

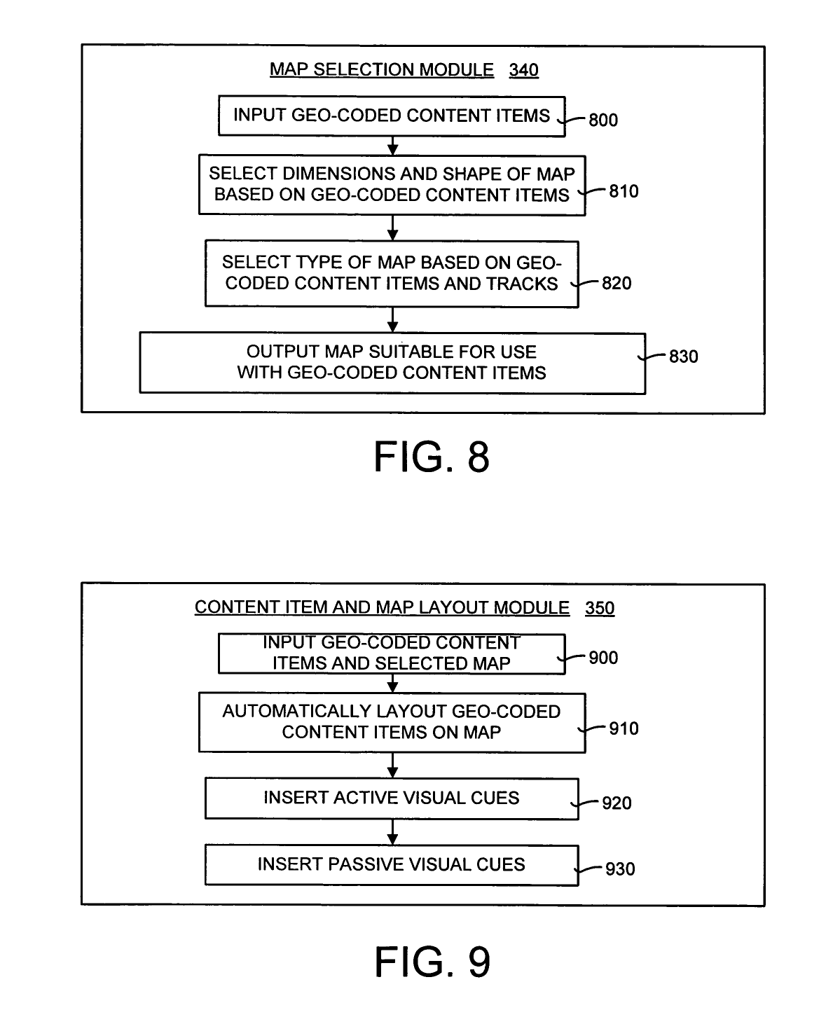

FIG. 8 is a flow diagram illustrating the detailed operation of the map selection module 340 shown in FIG. 3. The map selection module 340 provides an automated selection of the map used in the geographic travelogue. This means that the map type, size and shape are automatically selected. More specifically, the geo-coded content items are input (box 800). The map's dimensions and shape are appropriately selected such based on the geo-coded content items (box 810). These map dimensions and shapes are selected such that a region covered by a number of content items is displayed. In an alternate embodiment, the map can also be selected such that tracks are displayed on the map.

The map type is automatically selected based on the geo-coded content items (box 820). This means that the map type is selected to be appropriate for the location covered by the content items. For example, if the majority of content items in a travelogue appear to follow a trail in the mountains, a topographical map may be selected instead of a city street map. The output is a map having a type, size and shape that are suitable for displaying the geo-coded content items (box 830).

FIG. 9 is a flow diagram illustrating the detailed operation of the content item and map layout module 350 shown in FIG. 3. This module 350 provides an automated layout of content items and selected maps within the travelogue. Geo-coded content items and selected maps are input (box 900). Next, the geo-coded content items are automatically arranged on an appropriate map (box 910). This automatic arrangement is intelligently performed such that each content item is on or near its associated geographic location.

Next, visual cues may be added. Visual cues show a relationship between a content item and its associated location. These visual cues can be active visual cues (box 920), passive visual cues (box 930), or both. Active cues dynamically change based on interaction from a user. For example, a spot on a map may be highlighted upon a user moving a mouse cursor (“mousing over”) a content item displayed on a map. Passive visual cues are statically viewable. For instance, a line connecting a content item with its location on the map.

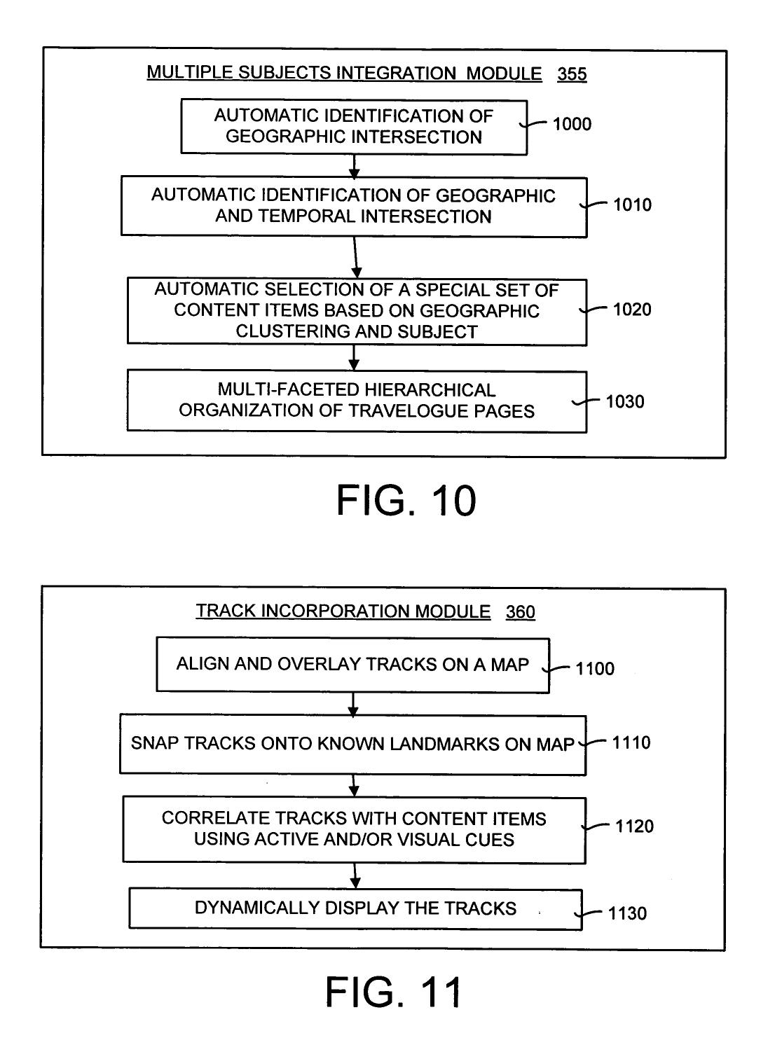

FIG. 10 is a flow diagram illustrating the detailed operation of the multiple-subjects-integration module 355 shown in FIG. 3. The module uses the subjects 130, content items 140 and tracks 150 to perform the following features. One feature is the automatic identification of geographic intersection between multiple subjects (box 1000). For example, if two subjects both visited the Space Needle in Seattle, the module 355 would note this and identify this location as a special location, with an optional hyperlink to the other relevant travelogues. In an alternate embodiment, a separate travelogue page is created. This separate page combines the content items of both subjects that geographically intersected.

Another feature is the automatic identification of geographic and temporal intersections (box 1010). This means that multiple subjects converged to the same location and at overlapping times. In an alternate embodiment, a separate travelogue page is created for this intersection, and combines the content items of all subjects that geographically and temporally intersected. Alternatively, such events may be marked specially in any travelogues that contain that instant at that location, and link to other relevant travelogue pages.

The module 355 also features the automatic selection of a special set of content items based on geographic clustering and subject (box 1020). For example, for each cluster of geo-coded content items, a representative set of photographs may be selected such that each subject (such as a person) who traveled on the trip is equally represented. Another feature is multi-faceted hierarchical organization of travelogue pages (box 1030). By way of example, two parallel sets of travelogue pages may be created. One page may be hierarchically organized by location clusters, while the other page may be hierarchically organized by subjects.

FIG. 11 is a flow diagram illustrating the detailed operation of the track incorporation module 360 shown in FIG. 3. This module 360 performs the automatic incorporation of tracks into the travelogue such that a viewer can experience the tracks in a number of different ways. The module 360 can align and overlay the tracks onto a selected map (box 1100). In addition, the module 360 can “snap” the tracks on known landmarks, such as roads (box 1110). Visual cues can also be used to correlate the tracks with content items (box 1120). The visual cues may be active, passive, or both. The tracks may also be dynamically displayed (box 1130). This typically means that the tracks are animated to show a path taken by the subjects. Linear or non-linear time scaling may be used to animate the tracks. Moreover, the animation can be made dependent on user input. For example, only portions of the path may be animated between mouse clicks. Alternatively, a user may designate a starting point and an ending point, with animation of the path occurring between those points.

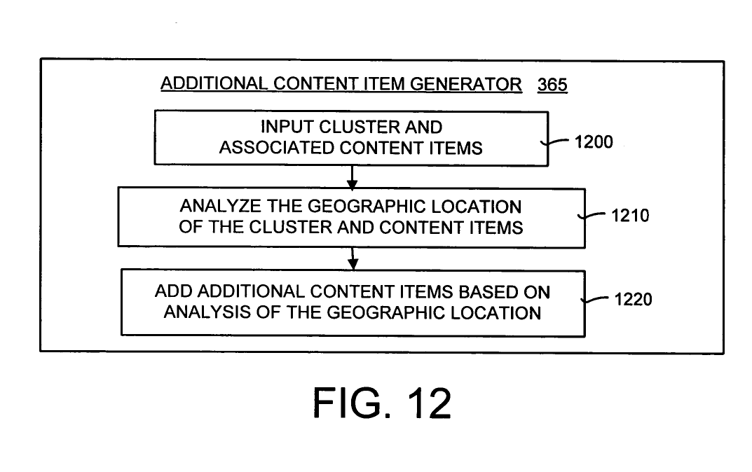

FIG. 12 is a flow diagram illustrating the detailed operation of the additional content item generator 365 shown in FIG. 3. This module 365 automatically creates additional content items relevant to an existing content item or cluster's location. The module 365 inputs a cluster and its associated content items (box 1200). Next, the geographic location of the cluster, content items, or both is analyzed (box 1210). Based on the analysis of the location, additional content items may be added (box 1220). For example, for each cluster of geo-coded content items, a hypertext link may be automatically generated that links to a web page showing different maps of the location, or links to a web page having more information about a location or an attraction.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description of the invention, but rather by the claims appended hereto.

1. A computer-implemented method for generating a geographic travelogue of a trip, comprising:
obtaining content items associated with the trip, the content items including any piece of information that is displayable on a computing device;
geographically coding the content items to tag the content items with geographic locations associated with the trip to create geo-coded content items; and
automatically integrating the geo-coded content items with other multimedia data associated with the trip to generate the geographic travelogue.

2. The computer-implemented method as set forth in claim 1, further comprising:
selecting a map displaying an area visited during the trip; and
automatically integrating the map into the geographic travelogue.

3. The computer-implemented method as set forth in claim 2, further comprising using a location resolver capable of converting between various location reference systems to resolve the geographic locations of the geo-coded content items.

4. The computer-implemented method as set forth in claim 3, further comprising converting the geographic locations of the geo-coded content items from a content item location reference system to map location reference system that is compatible with the selected map.

5. The computer-implemented method as set forth in claim 1, further comprising using a clustering technique to cluster the geo-coded content items into clusters based on the geographic locations of the geo-coded content items.

6. The computer-implemented method as set forth in claim 5, further comprising integrating each of the clusters of geo-coded content items into the geographic travelogue.

7. The computer-implemented method as set forth in claim 2, further comprising selecting a size, a shape, and a type of the map based on the geographic locations of the geo-coded content items.

8. The computer-implemented method as set forth in claim 5, further comprising generating additional content items relevant to the at least one of: (a) the geo-coded content items; (b) the clusters.

9. The computer-implemented method as set forth in claim 2, further comprising automatically arranging the geo-coded content items and the map within the geographic travelogue.

10. The computer-implemented method as set forth in claim 1, further comprising:
determining subjects of the trip, the subjects including a person, objects, or a set thereof that traveled together on the trip over an interval of time; and
automatically integrating geo-coded content items from several subjects into the geographic travelogue.

11. The computer-implemented method as set forth in claim 1, further comprising:
defining tracks as a record of where a subject traveled during the trip over an interval of time, the subject including at least one of: (a) a person; (b) an object; and
automatically incorporating the tracks into the geographic travelogue such that the tracks are intelligently positioned within the geographic travelogue.

12. A computer-readable medium having computer-executable instructions for performing the computer-implemented method recited in claim 1.

13. A computer-readable medium having computer-executable instructions for facilitating automated inclusion of maps and other geographical data into travelogues about a trip, comprising:
tagging pieces of trip information, which are displayable in the travelogue, with their associated geographic locations from the trip to produce geo-coded content items;
automatically selecting sizes, shapes, and types of maps based on the geographic locations of the geo-coded content items; and
automatically incorporating the maps and the geo-coded content items with other multimedia data to produce a geographic travelogue.

14. The computer-readable medium of claim 13, further comprising:
obtaining tracks of the trip, where tracks includes a record of where a subject traveled over a span of time; and
automatically selecting sizes, shapes, and types of maps based on the tracks.

15. The computer-readable medium of claim 13, wherein other multimedia data includes video, photographs, and blocks of text about the trip.

16. The computer-readable medium of claim 13, further comprising:
expressing geographic locations on the maps in a map location reference system;
expressing geographic locations associated with the geo-coded content items in a content item location reference system; and
converting the geo-coded content items from a geographic location expressed in the content item location reference system to the map location reference system.

17. The computer-readable medium of claim 13, further comprising generating clusters of geo-coded content items using a clustering technique based on the geographic locations.

18. The computer-readable medium of claim 17, wherein the clustering technique includes at least one of: (a) agglomerative clustering; (b) k-means clustering; (c) expectation-maximization clustering.

19. The computer-readable medium of claim 17, further comprising simplifying an appearance of the geo-coded content items on a map by reducing a number of visual elements representing the geo-coded content items.

20. The computer-readable medium of claim 17, further comprising creating a hierarchical organization of travelogue pages based the clusters.

21. The computer-readable medium of claim 17, further comprising dividing the geographic travelogue in a plurality of separate geographic travelogues based on the clusters.

22. The computer-readable medium of claim 17, further comprising:
determining whether to exclude certain ones of the geo-coded content items from a cluster based on a comparison between the cluster and the remaining clusters; and
automatically giving a title to a cluster based on the geo-coded content items contained in the cluster.

23. The computer-readable medium of claim 22, wherein determining whether to exclude certain ones of the geo-coded content items from a cluster further comprises at least one of: (a) a random selection process; (b) a representative-item selection process that creates sub-clusters of items based on a similarity metric and selects a limited number of sub-clusters from each cluster; (c) an elimination of a single-item cluster.

24. The computer-readable medium of claim 13, further comprising arranging the geo-coded content items on corresponding maps such that each of the geo-coded content items is on or near its geographic location represented on the maps.

25. The computer-readable medium of claim 24, further comprising inserting visual cues in the geographic travelogue to show a relationship between the geo-coded content items and their corresponding geographic locations.

26. The computer-readable medium of claim 25, wherein the visual cues include at least one of: (a) active visual cues that dynamically change based on user interaction with the geographic travelogue; (b) passive visual cues that are statically viewable in the geographic travelogue.

27. The computer-readable medium of claim 13, further comprising automatically identifying geographic intersections in the trip, where geographic intersections are geographic locations where two or more subjects have visited.

28. The computer-readable medium of claim 13, further comprising automatically identifying geographic and temporal intersections in the trip, where geographic and temporal intersections are geographic locations where two or more subjects visited at overlapping times.

29. The computer-readable medium of claim 28, further comprising creating a separate travelogue at an intersection of the geographic and temporal intersections, wherein content items of all subjects that geographic and temporal intersect are combined.

30. The computer-readable medium of claim 28, further comprising uniquely marking the geographic and temporal intersections in other travelogues and generating link to the other travelogues.

31. The computer-readable medium of claim 17, further comprising automatically selecting a special set of content items based on the clusters and subjects that were part of the trip.

32. The computer-readable medium of claim 17, further comprising performing multi-faceted hierarchical organization of pages of the geographic travelogue based on the clusters and subjects of the trip.

33. The computer-readable medium of claim 14, further comprising:
aligning and overlaying the tracks on the maps; and
snapping the tracks onto known landmarks on the maps.

34. The computer-readable medium of claim 14, further comprising correlating the tracks with the geo-coded content items using visual cues that show a relationship between the geo-coded content items and their corresponding geographic locations.

35. The computer-readable medium of claim 14, further comprising dynamically displaying the tracks on the maps in an animated manner.

36. The computer-readable medium of claim 17, further comprising:
analyzing the geographic locations of the clusters and geo-coded content items; and
adding more content items to the geographic travelogue based on the analysis.

37. A geographic travelogue authoring system for authoring on a computing device a geographic travelogue of a trip, comprising:
a content item, wherein the content item includes a piece of information associated with the trip that is displayable on the computing device;
a geographic coder that marks the content item with its associated geographic location from the trip to produce a geo-coded content item;
a map selection module that selects a map that corresponds to the geographic location of the geo-coded content item; and
a content item and map layout module that automatically incorporates the geo-coded content items, maps, and other multimedia data associated with the trip to produce the geographic travelogue.
